(19) United States
(12) Patent Application Publication
(10) Pub. No.: US 2020/0107167 A1
(43) Pub. Date: Apr. 2, 2020

(54) DATA COLLECTION METHOD AND NETWORK

(71) Applicant: Weilong Li, Chicago, IL (US)

(72) Inventor: Weilong Li, Chicago, IL (US)

(21) Appl. No.: 16/147,363

(22) Filed: Sep. 28, 2018

(51) Int. Cl. H04W 4/38; G06K 19/07; H04L 29/08

(52) U.S. Cl. CPC H04W 4/38; G06K 19/0701; H04L 67/12; G06K 19/0716

(57) ABSTRACT

This invention concerns a data collection network capable of collecting data from a group of users, said data collection network comprising a data collection apparatus associated with each of individual user of said group of users; a closed container associated with each of said data collection apparatus, said closed container containing a medium, said data collection apparatus disposed within said medium; a central server, said central server being an independent server or a plurality of decentralized servers connected through internet; a telecommunication apparatus associated with each of said data collection apparatus, said telecommunication apparatus wirelessly coupling said data collection apparatus to said central server; a database associated with each of said data collection apparatus, said database containing said data collected by said data collection apparatus, said database being administrated by said central server; and a central database, said central database being administrated by said central server.

### BACKGROUND OF THE INVENTION

### Field of the Invention

The present invention relates to a data collection method and a data collection network associated therewith. More specifically, my invention is primarily relates to a data collection method that is capable of collecting data through a smart probe submerged in a medium within a closed container for impacts on the outside surface of the closed container. Such group of smart probes can be wirelessly connected together through a wireless data collection network. The data collected by such data collection network can be monitored and analyzed by a central server. Such data collection method is capable of monitoring the impacts on the outside surface of a group of closed containers by the smart probe submerged in the medium each of such closed containers contains. The current invention provides a data collection method and associated network capable of collecting data from a group of users. The current invention enables the development of a central database that includes information collected from a group of users. The current invention further enables the development of algorithm for the monitoring and analysis of data collected. The current invention still further provides a method to improve the accuracy, effectiveness and efficiency of said algorithm.

### Description of the Prior Art

Data collection methods and networks have been widely adopted to collect and monitor data. Submerged smart probes are usually used to monitor and measure the content or status of the medium in a container.

U.S. Pat. No. 7,470,060 issued to Hoben et al. in December 2008 discloses a detection apparatus for measuring fluid in a vessel. Such vessel comprises at least one processor for receiving, processing and storing data from sensors in the vessel, at least one vertical support disposed within the vessel and at least one pair of sensors connected to the at least one vertical support. The sensors continuously provide measurement data to the processor, wherein the processor synchronously polls measurement data from the sensors, continuously calculates values, and compares the calculated values to at least one predetermined range of values for the fluid in the vessel to identify whether the calculated values are within the predetermined values. The processor communicates the compared value to a data collector.

U.S. Pat. No. 9,217,686 issued to Li et al. in December 2015 provides a method, apparatus, and system for monitoring the state of a fluid transport pipe. In one embodiment, there is provided a method of monitoring the state of a fluid transport pipe, the method including: causing a monitor to move along with a fluid inside the fluid transport pipe, the monitor including an elastic gas container and being configured to adjust the volume of the elastic gas container based on ambient pressure of the elastic gas container; and measuring and recording, by the monitor, one or more types of environmental data inside the fluid transport pipe for determining the state of the fluid transport pipe. In other embodiments, there are further provided an apparatus and system for monitoring a state of fluid transport pipe.

U.S. Pat. No. 9,347,848 issued to Westmoreland et al. in May 2016 discloses a marine probe with no moving parts for use in one or more tanks on a floating vessel. The marine probe has pressure transducers, temperature sensors, an inclinometer, and a probe processor electrically connected to the pressure transducers, temperature sensors, inclinometer and a probe data storage. The marine probe controls the temperature sensors and pressure transducers to produce bidirectional signals and calculate at least one physical property, performs adaptive measurement for dynamic and static synchronized and non-synchronized measurement, identifies temperature sensors and pressure transducers not covered by the fluid, measures multiple parameters of the fluid in the tank, calibrates pressure transducers in a vapor space of the tank when the pressure transducers are no longer in the fluid, and creates bidirectional signals using values from the inclinometer transferring the bidirectional signals to a client device via a network.

U.S. Pat. No. 9,535,021 issued to Kamen et al. in January 2017 discloses a sensor apparatus and sensor apparatus system for use in conjunction with a cassette, including a disposable or replaceable cassette. In some embodiments, the cassette includes a thermal well for permitting the sensing of various properties of a subject media. The thermal well includes a hollow housing of a thermally conductive material. In other embodiments, the cassette includes sensor leads for sensing of various properties of a subject media. The thermal well has an inner surface shaped so as to form a mating relationship with a sensing probe. The mating thermally couples the inner surface with a sensing probe. In some embodiments, the thermal well is located on a disposable portion and the sensing probe on a reusable portion.

The prior arts do not disclose any invention related to a data collection method and network that is capable of collecting data from and monitoring data of a group of users altogether. The prior arts do not disclose any invention related to a data collection method and network that is capable of collecting impact data on the outside surface of a closed container. The prior arts do not disclose any invention related to a data collection method and network that is capable of collecting impact data of outside surface of a group of closed containers. The prior arts do not disclose any invention related to a data collection method and network that is capable of developing an individual database for each said individual user from said data, and a central database based on all or some of these individual database associated with said group of users. The prior arts do not disclose any invention related to a data collection method and network that is capable of improving its accuracy, effectiveness and efficiency over the time.

What is needed then is to a data collection method and network that is capable of collecting data from and monitoring data of a group of users altogether; a data collection method and network that is capable of collecting impact data on outside surface of a closed container; a data collection network that is capable of collecting impact data of outside surface of a group of closed containers; a data collection method and network that is capable of developing an individual database for each said individual user from said data, and a central database based on all or some of these individual database associated with said group of users; and a data collection method and network that is capable of improving its accuracy, effectiveness and efficiency over the time.

Accordingly, it is a principal objective of my invention to provide a data collection network that is capable of collecting data from and monitoring data of a group of users altogether.

It is a further objective of my invention to provide a data collection method and network that is capable of collecting impact data on outside surface of a closed container.

It is a still further objective of my invention to provide a data collection method and network that is capable of collecting impact data of outside surface of a group of closed containers.

It is a still further objective of my invention to provide a data collection method and network that is capable of developing an individual database for each said individual user from said data, and a central database based on all or some of these individual database associated with said group of users.

It is a still further objective of my invention to provide a data collection method and network that is capable of improving its accuracy, effectiveness and efficiency over the time . . . .

Other objects of my invention, as well as particular features, elements, and advantages thereof, will be elucidated in, or apparent from, the following description and the accompanying drawing figures.

### SUMMARY OF THE INVENTION

This summary is provided to introduce a selection of concepts in a simplified form that are further described below in the Detailed Description section. This summary is not intended to identify key features or essential features of the claimed subject matter, nor is it intended to be used as an aid in determining the scope of the claimed subject matter.

According to my present invention, I have provided a data collection network capable of collecting data from a group of users. Said data collection network comprises a data collection apparatus associated with each of individual user of said group of users; a closed container associated with each of said data collection apparatus, said closed container containing a medium, said data collection apparatus disposed within said medium; a central server, said central server being an independent server or a plurality of decentralized servers connected through internet; a telecommunication apparatus associated with each of said data collection apparatus, said telecommunication apparatus wirelessly coupling said data collection apparatus to said central server; a database associated with each of said data collection apparatus, said database containing said data collected by said data collection apparatus, said database being administrated by said central server; and a central database, said central database being administrated by said central server.

Said data collection apparatus comprises a power source apparatus, said power source apparatus capable of providing power to said data collection apparatus; a timing apparatus, said timing apparatus capable of providing date and time information to said data collection apparatus; a data collecting apparatus, said data collecting apparatus capable of continuously or periodically collecting said data associated with said individual user, said data being physical data, chemical data, biological data, physiological data, or similar, according to a proprietary algorithm; a data processing apparatus, said data processing apparatus capable of administrating said data collection apparatus and processing said data collected by said data collecting apparatus, according to said proprietary algorithm; a data storing apparatus, said data storing apparatus capable of storing said data for a period of time, according to said proprietary algorithm; and a data communicating apparatus, said data communicating apparatus capable of communicating said data to said central server through said telecommunication apparatus, according to said proprietary algorithm.

Said central server is capable of developing said central database by using some or all of said data from some or all of said database associated with said group of users, analyzing said database, said central database, or a combination thereof, to generate a plurality of reports on said individual user, according to said proprietary algorithm.

Said plurality of reports, used and analyzed in association with said data, from said database, said central database, or a combination thereof, can be used to determine past physical, past biological, past physiological, or past similar condition, and predict future physical, future biological, future physiological, or future similar condition, of said individual user, according to said proprietary algorithm.

Said proprietary algorithm can be improved and modified either manually by an administrator or automatically by said central server based on information associated with said data, said database, said central database, or a combination thereof.

The present invention also provides a data collection method capable of collecting data from a group of users, Said data collection method comprises providing a data collecting means associated with each of individual user of said group of users; providing a closed container means associated with each of said data collecting means, said closed container means containing a medium, said data collecting means disposed within said medium; providing a central server, said central server being an independent server or a plurality of decentralized servers connected through internet; providing a telecommunication means associated with each of said data collecting means, said telecommunication means wirelessly coupling said data collecting means to said central server; developing a database associated with each of said data collecting means, said database containing said data collected by said data collecting means, said database being administrated by said central server according to a proprietary algorithm; and developing a central database, said central database being administrated by said central server according to said proprietary algorithm.

Said data collecting means comprises a powering means, said powering means capable of providing power to said data collecting means; a timing means, said timing means capable of providing date and time information to said data collecting means; a sensor means, said sensor means being either an individual sensor means or a plurality of sensor means, said sensor means capable of continuously or periodically collecting said data associated with said individual user, said data being physical data, chemical data, biological data, physiological data, or similar, according to said proprietary algorithm; a processor, said processor capable of administrating said data collecting means and processing said data, according to said proprietary algorithm; a data storing means, said data storing means capable of storing said data for a period of time, according to said proprietary algorithm; and a data communicating means, said data communicating means capable of communicating said data to said central server through said telecommunication means, according to said proprietary algorithm.

Said central server is capable of developing a report, said report being a single report or a plurality of reports, on said individual user based on said data in association with said database, said central database, or a combination thereof, according to said proprietary algorithm.

Said data, said database, said central database, or a combination thereof, can be used to determine past physical, past biological, past physiological, or past similar condition, and predict future physical, future biological, future physiological, or future similar condition, of said individual user, according to said proprietary algorithm.

Said proprietary algorithm can be improved and modified either manually by an administrator or automatically by said central server, according to said proprietary algorithm itself, based on information associated with said data, said database, said central database, or a combination thereof.

The present invention can be used in association with a sleeping mattress filled with a liquid medium. The present invention can be used to monitor an individual user's sleeping and resting habit. The present invention can collect and store the impact data of said individual user on said sleeping mattress. Said data can be analyzed to show said individual's sleeping habit, sleeping quality, sleeping style, sleeping time, and similar. Said data gathered from said individual user can be used to track past history of said individual user's sleeping and rest length and quality. A sleeping and resting history report can be developed for said individual user of such data collection network.

The present invention can also be used as a data collecting network to collect data from a group of users. Said data can be used to develop a central database. Said central database can be used to analyze the common sleeping and resting habit of said group of users in association with their existing health condition to predict their future health condition.

Further embodiments, features, and advantages of the present invention, as well as the structure and operation of various embodiments of the present invention, are described in detail below with reference to accompanying drawings.

Other technical advantages will be readily apparent to one skilled in the art from the following figures, descriptions and claims. Moreover, while specific advantages have been enumerated above, various embodiments may include all, some or one of the enumerated advantages.

Embodiments may be implemented as a computer, a computer process, a computing system or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instruction for executing a computer process.

### DESCRIPTION OF THE DRAWINGS

Other features of my invention will become more evident from a consideration of the following detailed description of my patent drawings, as follows:

FIG. 1 is a structure demonstration drawing of a first preferred embodiment of a data collection network.

FIG. 2 is a structure demonstration drawing of a Data Collection Apparatus of the first preferred embodiment of a data collection network.

FIG. 3 is a flow chart for collecting data from User A by using the first preferred embodiment of a data collection network.

FIG. 4 is a structure demonstration drawing of said central server to develop a central database and generate various reports based on a proprietary algorithm.

FIG. 5 is a structure demonstration drawing of a second preferred embodiment of a data collection network.

FIG. 6 is a structure demonstration drawing of a Data Collection Apparatus A of the second preferred embodiment of a data collection network.

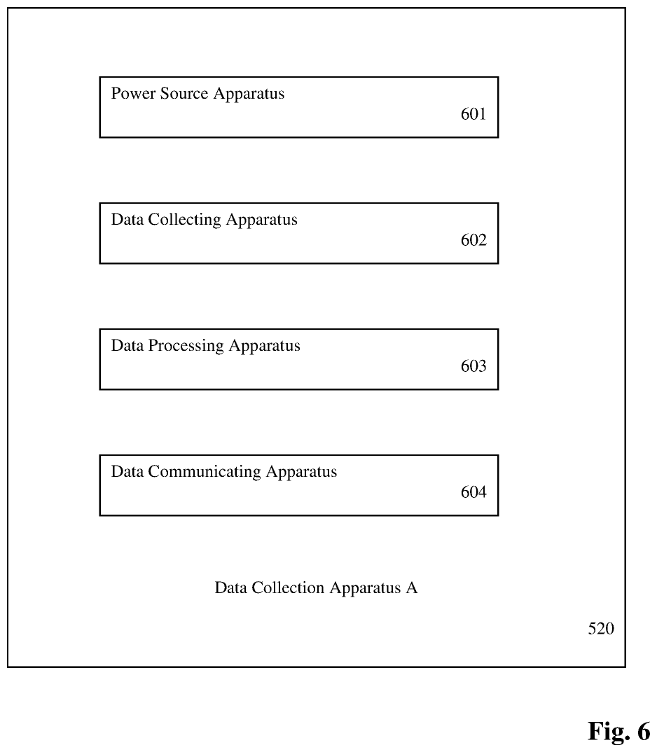

FIG. 7 is a flow chart for collecting data from a group of users and generate various reports by using the second preferred embodiment of a data collection network.

### DETAILED DESCRIPTION OF THE PREFERRED EMBODIMENT

Various embodiments are described more fully below with reference to the accompanying drawings, which form a part hereof, and which show specific embodiments for practicing the embodiments described herein. However, embodiments may be implemented in many different forms and should not be construed as limited to the embodiments set forth herein; rather, these embodiments are provided so that this disclosure will be thorough and complete, and will fully convey the scope of the invention to those skilled in the art. Embodiments may be practiced as methods, systems, or devices. Accordingly, embodiments may take the form of a hardware implementation, an entirely software implementation or an implementation combing software and hardware aspects.

Referring now to the drawings, my invention concerns a data collection method and network capable of collecting data from a group of users.

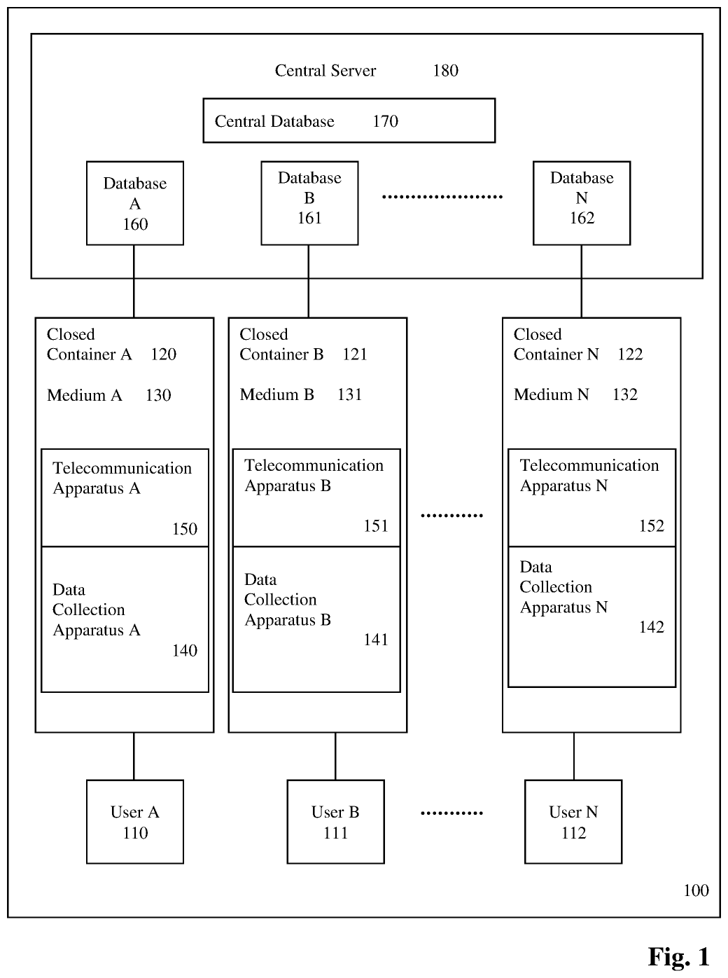

Referring now to FIG. 1, which is a structure demonstration drawing of a first preferred embodiment of a data collection network 100. Said data collection network 100 is capable of collecting data from a group of individual users, including User A 110, User B 111 through User N 112. Each one of said group of individual users is associated with a closed container. Such closed container can be a mattress, a bag, a wearable, or other similar object filling with a medium, such as water, liquid, air, or other similar medium. User A 110 is associated with Closed Container A 120; User B 111 is associated with Closed Container B 121; and User N 112 is associated with Closed Container N 122. Closed Container A 120 is filled with medium A 130; Closed Container B 121 is filled with medium B 131; and Closed Container N 122 is filled with medium N 132. Medium A 130, Medium B 131 through Medium N 132 can either be identical medium, similar medium, different medium, or a combination thereof. Each one of said group of users is associated with a data collection apparatus. User A 110 is associated with Data Collection Apparatus A 140; User B 111 is associated with Data Collection Apparatus B 141; and User N 112 is associated with Data Collection Apparatus N 142. A telecommunication apparatus is associated with each of said data collection apparatus, said telecommunication apparatus wirelessly coupling said data collection apparatus to a central server 180. Telecommunication Apparatus A 150 is associated with Data Collection Apparatus A 140, said Telecommunication Apparatus A 150 wirelessly coupling said Data Collection Apparatus A 140 to said central server 180; Telecommunication Apparatus B 151 is associated with Data Collection Apparatus B 141, said Telecommunication Apparatus B 151 wirelessly coupling said Data Collection Apparatus B 141 to said central server 180; and Telecommunication Apparatus N 152 is associated with Data Collection Apparatus N 142, said Telecommunication Apparatus N 152 wirelessly coupling said Data Collection Apparatus N 142 to said central server 180. A database is associated with each of said data collection apparatus, said database containing said data collected by said data collection apparatus. Database A 160 is associated with Data Collection Apparatus A 140, said Database A 160 containing said data collection by said Data Collection Apparatus A 140; Database B 161 is associated with Data Collection Apparatus B 141, said Database B 161 containing said data collection by said Data Collection Apparatus B 141; and Database N 162 is associated with Data Collection Apparatus N 142, said Database N 162 containing said data collection by said Data Collection Apparatus N 142. Said Database A 160, Database B 161 through Database N 162 are administrated by said central server 180. A central database 170 is developed by said central server 180 based on said data from said Database A 160, Database B 161 through Database N 162. Said central database 170 is administrated by said central server 180. Said central server 180 can be an independent server or a plurality of decentralized servers connected through internet.

Said central server 180 is capable of developing said central database 170 by using some or all of said data from some or all of said database, such as Database A 160, Database B 161 through Database N 162, analyzing said Database A 160, said Database B 161 through said Database N 162, said central database 170, or a combination thereof, to generate a plurality of reports on said individual user, such as User A 110, User B 111, and User N 112, according to a proprietary algorithm.

Said plurality of reports, used and analyzed in association with said data, from said database, such as said Database A 160, Database B 161, and Database N 162, said central database 170, or a combination thereof, can be used to determine past physical, past biological, past physiological, or past similar condition, and predict future physical, future biological, future physiological, or future similar condition, of said individual user. Such as User A 110, User B 111 through User N 112, according to said proprietary algorithm.

Said proprietary algorithm can be improved and modified either manually by an administrator or automatically by said central server 180 based on information associated with said data, said database, such as Database A 160, Database B 161, and Database N 162, said central database 170, or a combination thereof.

Data Collection Apparatus A 140, Data Collection Apparatus B 141, and Data Collection Apparatus N 142 are similar or identical, which are capable of collecting data through Medium A 130, Medium B 131, and Medium N 132, representing impacts of User A 110, User B 111, and User N 112, respectively, with Closed Container A 120, Closed Container B 121, and Closed Container N 122, respectively. Said data collected by Data Collection Apparatus A 140, Data Collection Apparatus B 141 through Data Collection Apparatus N 142, is communicated to said central server 180 through Telecommunication Apparatus A 150, Telecommunication Apparatus B 151, and Telecommunication Apparatus N 152, respectively, and used by said central server 180 to develop and modify Database A 160, Database B 161, and Database N 162, respectively. Said central server 180 further develops said central database 170 by using said data and based on Database A 160, Database B 161 through Database N 162, a part thereof, or a combination thereof, according to said proprietary algorithm.

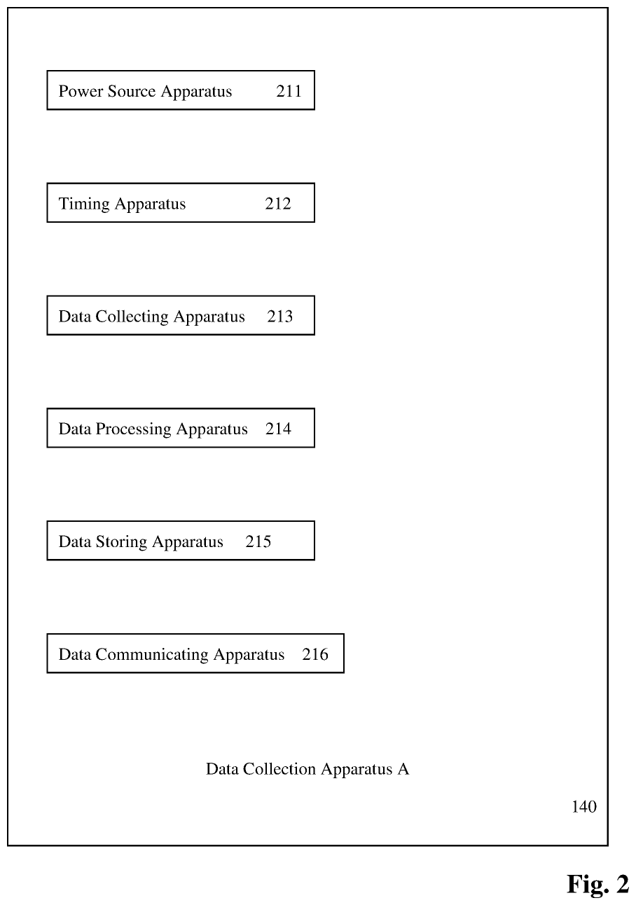

Referring now to FIG. 2, which is a structure demonstration drawing of a Data Collection Apparatus A of the first preferred embodiment, and in association with FIG. 1. Said Data Collection Apparatus A 140 comprises a power source apparatus 211, said power source apparatus 211 is capable of providing power to said Data Collection Apparatus A; a timing apparatus 212, said timing apparatus 212 is capable of providing date and time information to said Data Collection Apparatus A 140; a data collecting apparatus 213, said data collecting apparatus 213 is capable of continuously or periodically collecting said data associated with said User A 110, said data being physical data, chemical data, biological data, physiological data, or similar, according to said proprietary algorithm; a data processing apparatus 214, said data processing apparatus 214 is capable of administrating said Data Collection Apparatus A 140 and processing said data collected by said Data Collecting Apparatus A 140, according to said proprietary algorithm; a data storing apparatus 215, said data storing apparatus 215 is capable of storing said data for a period of time, according to said proprietary algorithm; and a data communicating apparatus 216, said data communicating apparatus 216 is capable of communicating said data to said central server 180 through said Telecommunication Apparatus A 150, according to said proprietary algorithm.

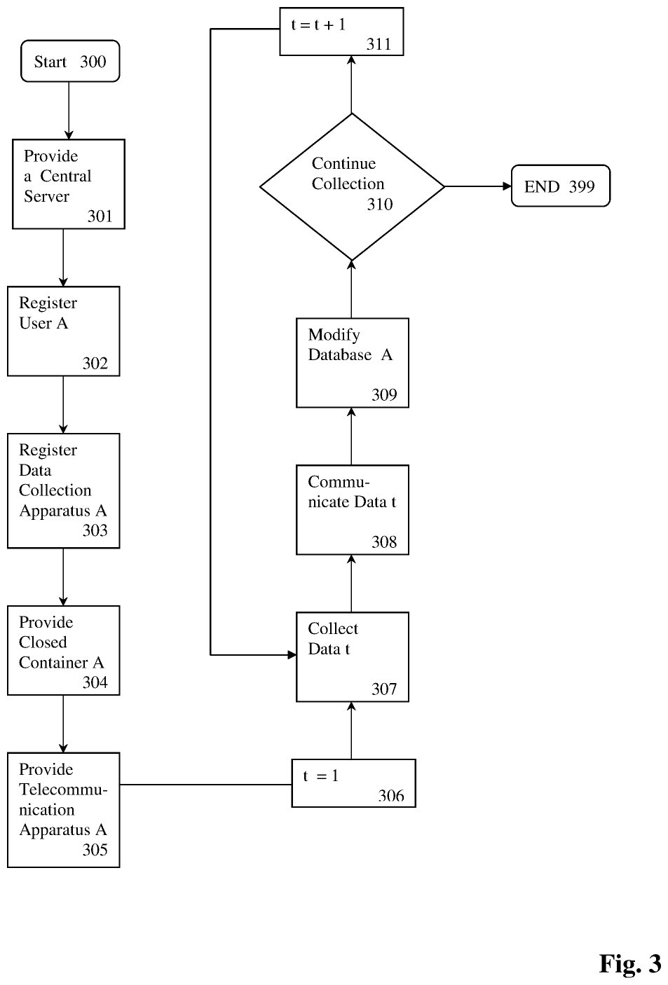

Referring now to FIG. 3, which is a flow chart for collecting data from User A by using the first preferred embodiment of a data collection network. The process of collecting data from a user starts at step 300, and proceeds to step 301. At step 301, the process provides a central server, said central server being an independent server or a plurality of decentralized servers connected through internet, and proceeds to step 302. At step 302 the process registers User A to said central server, and proceeds to step 303. At step 303, the process provides a Data Collection Apparatus A to User A, said Data Collection Apparatus A being registered with said central server, and proceeds to step 304. At step 304, the process provides a Closed Container A associated with said Data Collection Apparatus A, said Closed Container A containing a Medium A, said Data Collection Apparatus A disposed within said Medium A, and proceeds to step 305. At step 305, the process provides a Telecommunication Apparatus A associated with said Data Collection Apparatus A, said Telecommunication Apparatus A wirelessly coupling said Data Collection Apparatus to said central server, and proceeds to step 306. At step 306, the process sets t=1, and proceeds to step 307. At step 307, the process collects data t by said Data Collection Apparatus A from said User A, said data representing User A's impact on said Closed Container A, and proceeds to step 308. At step 308, the process communicates said data t by said Data Collection Apparatus A to said central server through said Telecommunication Apparatus A, and proceeds to step 309. At step 309, the process establishes and/or modifies Database A associated with Data Collection Apparatus A using said data t, said Database A containing said data t, said Database A being administrated by said central server, and proceeds to step 310. At step 310, the process determines if continuation of data collection is needed. If the process determines yes at step 310, the process proceeds to step 311. At step 311, the process sets t=t+1, and proceeds to step 307. If the process determines no at step 310, the process proceeds to step 399. At step 399, the process ends itself.

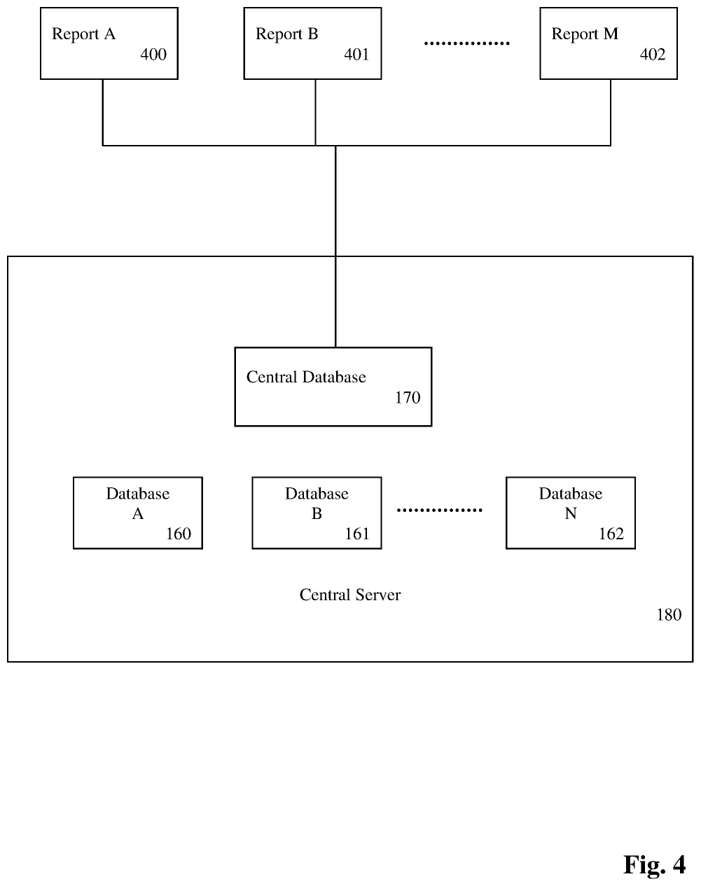

Referring now to FIG. 4, which is a structure demonstration drawing of said central server to develop a central database and generate various reports based on a proprietary algorithm. Said central server 180 is capable of developing said central database 170 by using some or all of said data from some or all of said database, such as Database A 160, Database B 161 through Database N 162, associated with said group of users, analyzing said database, including Database A 160, Database B 161 through Database N 162, said central database 170, or a combination thereof, to generate a plurality of reports, including Report A 400, Report B 401 through Report M 402, on said individual user, according to said proprietary algorithm.

Said plurality of reports, including Report A 400, Report B 401 through Report M 402, used and analyzed in association with said data, from said database, including Database A 160, Database B 161 through Database N 162, said central database 170, or a combination thereof, can be used to determine past physical, past biological, past physiological, or past similar condition, and predict future physical, future biological, future physiological, or future similar condition, of said individual user, according to said proprietary algorithm.

Said proprietary algorithm can be improved and modified either manually by an administrator or automatically by said central server 180 based on information associated with said data, said database, including Database A 160, Database B 161 through Database N 162, said central database 170, or a combination thereof.

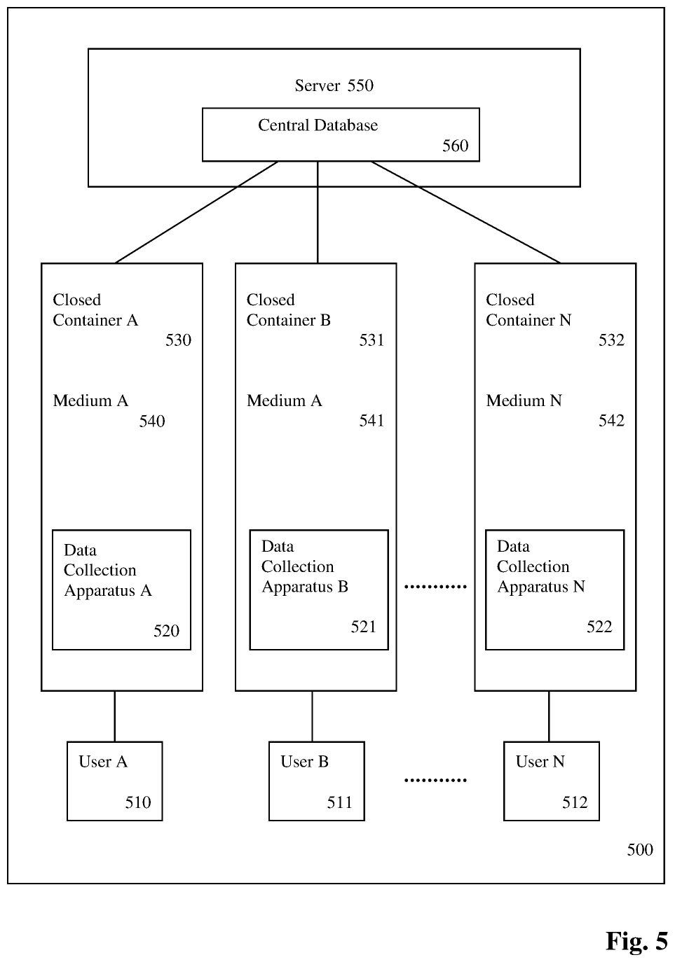

Referring now to FIG. 5, which is a structure demonstration drawing of a second preferred embodiment of a data collection network. A data collecting network 500 capable of collecting data from a group of users, including User A 510, User B 511 through User N 512, comprises a data collection apparatus for each of individual user of said group of users, Data Collection Apparatus A 520 for User A 510, Data Collection Apparatus B 521 for User B 511, and Data Collection Apparatus N 522 for User N 512; a closed container associated with each of said data collection apparatus, said closed container having a medium, said data collection apparatus submerged within said medium, Closed Container A 530 associated with Data Collection Apparatus A 520, said Closed Container A 530 having Medium A 540, said Data Collection Apparatus A 520 submerged within said Medium A 540, Closed Container B 531 associated with Data Collection Apparatus B 521, said Closed Container B 531 having Medium B 541, said Data Collection Apparatus B 521 submerged within said Medium B 541, Closed Container N 532 associated with Data Collection Apparatus N 522, said Closed Container N 532 having Medium N 542, said Data Collection Apparatus N 522 submerged within said Medium N 542; a server 550, said server 550 remotely coupled with said data collection apparatus, including said Data Collection Apparatus A 520, said Data Collection Apparatus B 521 through said Data Collection Apparatus N 522; and a central database 560, said central database 560 being administrated by said server 550 according to a computer algorithm.

Each of said Data Collection Apparatus A 520, said Data Collection Apparatus B 521 through Said Data Collection Apparatus N 522, is capable of collecting said data, either continuously or periodically, through said Medium A 540, Medium B 541 through Medium N 542, respectively, and from said User A 510, User B 511 through User N 512, respectively, representing impact of said User A 510 with said Closed Container A 530, said User B 511 with said Closed Container B 531, or said User N 512 with said Closed Container N 532, respectively, said data being physical data, chemical data, biological data,

periodically, through said Medium A 540 and from said User A 510, according to said computer algorithm; a data processing apparatus 603, said data processing apparatus 603 capable of administrating said Data Collection Apparatus A 520 according to said computer algorithm; and a data communicating apparatus 604, said data communicating apparatus 604 capable of communicating said data to said server 550 according to said computer algorithm.

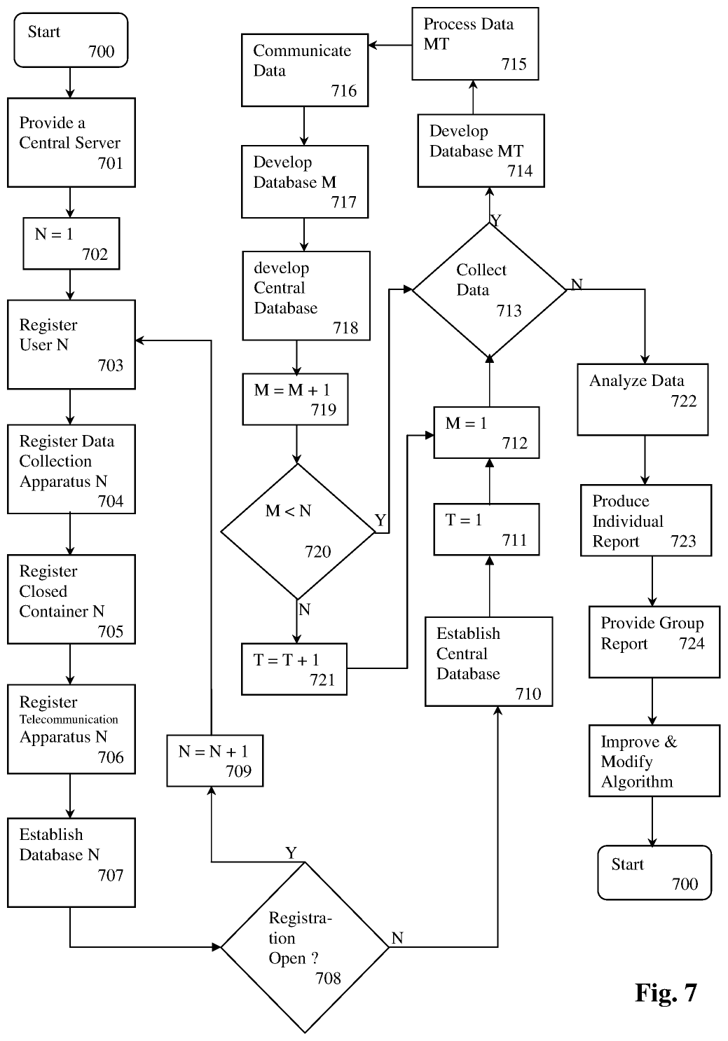

Referring now to FIG. 7, which is a flow chart for collecting data from a group of users and generate various reports by using the second preferred embodiment of a data collection network. The process starts at step 700, and proceeds to step 701. At step 701, the process provides a central server, said central server being an independent server or a plurality of decentralized servers connected through internet, and proceeds to step 702. At step 702, the process sets N=1, and proceeds to step 703. At step 703, the process registers User N to said central server, and proceeds to step 704. At step 704, the process registers a Data Collection Apparatus N to User N and said central server, and proceeds to step 705. At step 705, the process registers a Closed Container N associated with said Data Collection Apparatus N to said central server, said Closed Container N containing a Medium N, said Data Collection Apparatus N disposed within said Medium N, and proceeds to step 706. At step 706, the process registers a Telecommunication Apparatus N associated with said Data Collection Apparatus N to said central server, said Telecommunication Apparatus N wirelessly coupling said Data Collection Apparatus N to said central server and capable of communicating with said central server, and proceeds to step 707. At step 707, the process establishes or modifies a Database N associated with said Data Collection Apparatus N, said Database N containing said data collected by said Data Collection Apparatus N and communicated to said central server, said Database N being administrated by said central server according to an algorithm, and proceeds to step 708. At step 708, the process determines whether the registration is still open. If the process determines yes at step 708, the process proceeds to step 709. At step 709, the process sets N=N+1, and proceeds to step 703. If the process determines no at step 708, the process proceeds to step 710. At step 710, the process establishes a central database, said central database being developed from said Database N and administrated by said central server according to said algorithm, and proceeds to step 711. At step 711, the process set T=1, and proceeds to step 712. At step 712, the process sets M=1, and proceeds to step 713. At step 713, the process determines if collection of data is needed. If the process determines yes at step 713, the process proceeds to step 714. At step 714, the process collects Data MT by said Data Collection Apparatus M from said User M through said Medium M either continuously or periodically, said Data MT describing and representing impact of said User M with said Closed Container M at time T, according to said algorithm, and proceeds to step 715. At step 715, said process processes said Data MT by said Data Collection Apparatus M according to said algorithm, and proceeds to step 716. At step 716, the process communicates said Data MT by said Data Collection Apparatus M to said central server through said Telecommunication Apparatus M according to said algorithm, and proceeds to step 717. At step 717, the process develops said Database M by said central server based on said Data MT according to said algorithm, and proceeds to step 718. At step 718, the process develops said central database by said central server based on said Data MT according to said algorithm, and proceeds to step 719. At step 719, the process sets M=M+1, and proceeds to step 720. At step 720, the process determines if M<N. If the process determines yes at step 720, the process proceeds to step 713. If the process determines no at step 720, the process proceeds to step 721. At step 721, the process sets T=T+1, and proceeds to step 712. If the process determines no at step 713, the process proceeds to step 722. At step 722, the process analyzes said Data MT, said Database M, said central database, a part thereof, or a combination thereof, by said central server, said Data Communication Apparatus M, said Data Collection Apparatus M, or a combination thereof, according to said algorithm, and proceeds to step 723. At step 723, the process produces an individual report, said individual report being a single individual report or a plurality of individual reports, on said User M, according to said algorithm, and proceeds to step 724. At step 724, the process produces a group report, said group report being a single group report or a plurality of group reports, on said group of individual users, or a sub-group of said group of individual users, according to said algorithm, and proceeds to step 725. At step 725, the process improves and modifies said algorithm either manually by an administrator or automatically by said server, according to said algorithm, based on information associated with said Data MT, said Database M, said central database, a part thereof, or a combination thereof, and proceeds to step 799. At step 799, the process ends itself.

Said Data Collection Apparatus M comprises at least a power source apparatus, said power source apparatus capable of providing power to said Data Collection Apparatus M; a timing apparatus, said timing apparatus capable of providing date and time information to said Data Collection Apparatus M; a data collecting apparatus, said data collecting apparatus capable of continuously or periodically collecting said data associated with said User M, according to said algorithm; a data processing apparatus, said data processing apparatus capable of administrating said Data Collection Apparatus M and processing said Data MT collected by said Data Collecting Apparatus M, according to said algorithm; a data storing apparatus, said data storing apparatus capable of storing said Data MT for a period of time, according to said algorithm; and a data communicating apparatus, said data communicating apparatus capable of communicating said Data MT to said central server through said Telecommunication Apparatus M, according to said algorithm.

Said individual report, used and analyzed in association with said Data MT, from said Database M, said central database, or a combination thereof, can be used to determine past condition, and predict future condition, of said User M, according to said algorithm.

Said group report, used and analyzed in association with said Data MT, from said Database M, said central database, or a combination thereof, can be used to determine past condition, and predict future condition, of said group of users, or a sub-group of said group of users, according to said algorithm.

As various possible embodiments may be made in the above invention for use for different purposes and as various changes might be made in the embodiments and methods above set forth, it is understood that all of the above matters here set forth or shown in the accompanying drawings are to be interpreted as illustrative and not in a limiting sense.

It is to be understood that the invention is not limited in its embodiments disclosed in the preceding description or illustration in the drawings. The invention is capable of other embodiments and of being practiced and carried out in various ways. It is to be understood that the phraseology and terminology employed herein are for the purpose of descriptions and illustrations, and should not b regarded as limitations.

The above description will enable any person skilled in the art to make and use this invention. It also sets forth the best embodiments for carrying out this invention. There are numerous variations and modifications thereof that will also remain readily apparent to others skilled in the art, now that the general principles of the present invention have been disclosed. As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

I claim:

1. A data collection network capable of collecting data from a group of users, said data collection network comprising:
a data collection apparatus associated with each of individual user of said group of users;
a closed container associated with each of said data collection apparatus, said closed container containing a medium, said data collection apparatus disposed within said medium;
a central server, said central server being an independent server or a plurality of decentralized servers connected through internet;
a telecommunication apparatus associated with each of said data collection apparatus, said telecommunication apparatus wirelessly coupling said data collection apparatus to said central server;
a database associated with each of said data collection apparatus, said database containing said data collected by said data collection apparatus, said database being administrated by said central server; and
a central database, said central database being administrated by said central server.

2. The data collection network of claim 1, wherein said data collection apparatus comprises
a power source apparatus, said power source apparatus capable of providing power to said data collection apparatus;
a timing apparatus, said timing apparatus capable of providing date and time information to said data collection apparatus;
a data collecting apparatus, said data collecting apparatus capable of continuously or periodically collecting said data associated with said individual user through said medium, said data being physical data, chemical data, biological data, physiological data, or similar, according to a proprietary algorithm;
a data processing apparatus, said data processing apparatus capable of administrating said data collection apparatus and processing said data collected by said data collecting apparatus, according to said proprietary algorithm;
a data storing apparatus, said data storing apparatus capable of storing said data for a period of time, according to said proprietary algorithm; and
a data communicating apparatus, said data communicating apparatus capable of communicating said data to said central server through said telecommunication apparatus, according to said proprietary algorithm.

3. The data collection network of claim 2, wherein said central server is capable of developing said central database by using some or all of said data from some or all of said database associated with said group of users, analyzing said database, said central database, a part thereof, or a combination thereof, to generate a plurality of reports on said individual user, according to said proprietary algorithm.

4. The data collection network of claim 3, wherein said plurality of reports, used and analyzed in association with said data, from said database, said central database, a part thereof, or a combination thereof, can be used to determine past physical, past biological, past physiological, or past similar condition, and predict future physical, future biological, future physiological, or future similar condition, of said individual user, according to said proprietary algorithm.

5. The data collection network of claim 4, wherein said proprietary algorithm can be improved and modified either manually by an administrator or automatically by said central server based on information associated with said data, said database, said central database, a part thereof, or a combination thereof.

6. A data collection method capable of collecting data from a group of users, said data collecting method comprising:
providing a central server, said central server being an independent server or a plurality of decentralized servers connected through internet;
providing a data collection apparatus to each of individual user of said group of users;
providing a closed container associated with each of said data collection apparatus, said closed container containing a medium, said data collection apparatus disposed within said medium;
providing a telecommunication apparatus associated with each of said data collection apparatus, said telecommunication apparatus wirelessly coupling said data collection apparatus to said central server;
collecting data by said data collection apparatus from said individual user;
communicating said data by said data collection apparatus to said central server through said telecommunication apparatus;
establishing a database associated with each of said data collection apparatus using said data, said database containing said data, said database being administrated by said central server; and
establishing a central database based on said database, said central database being administrated by said central server.

7. The data collection method of claim 6, wherein said data collection apparatus comprises
a power source apparatus, said power source apparatus capable of providing power to said data collection apparatus;
a timing apparatus, said timing apparatus capable of providing date and time information to said data collection apparatus;
a data collecting apparatus, said data collecting apparatus capable of continuously or periodically collecting said data associated with said individual user through said medium, said data being physical data, chemical data, biological data, physiological data, or similar, according to a proprietary algorithm;
a data processing apparatus, said data processing apparatus capable of administrating said data collection apparatus and processing said data collected by said data collecting apparatus, according to said proprietary algorithm;
a data storing apparatus, said data storing apparatus capable of storing said data for a period of time, according to said proprietary algorithm; and
a data communicating apparatus, said data communicating apparatus capable of communicating said data to said central server through said telecommunication apparatus, according to said proprietary algorithm.

8. The data collection method of claim 6, wherein said central server is capable of developing said central database by using some or all of said data from some or all of said database associated with said group of users, analyzing said database, said central database, a part thereof, or a combination thereof, to generate a plurality of reports on said individual user, according to said proprietary algorithm.

9. The data collection method of claim 6, wherein said plurality of reports, used and analyzed in association with said data, from said database, said central database, a part thereof, or a combination thereof, can be used to determine past physical, past biological, past physiological, or past similar condition, and predict future physical, future biological, future physiological, or future similar condition, of said individual user, according to said proprietary algorithm.

10. The data collection method of claim 6, wherein said proprietary algorithm can be improved and modified either manually by an administrator or automatically by said central server based on information associated with said data, said database, said central database, a part thereof, or a combination thereof.

11. A data collection network capable of collecting data from a group of users, said data collecting network comprising:
means and computer means for providing a central server, said central server being an independent server or a plurality of decentralized servers connected through internet;
means and computer means for providing a data collection apparatus to each of individual user of said group of users;
means and computer means for providing a closed container associated with each of said data collection apparatus, said closed container containing a medium, said data collection apparatus disposed within said medium;
means and computer means for providing a telecommunication apparatus associated with each of said data collection apparatus, said telecommunication apparatus wirelessly coupling said data collection apparatus to said central server;
means and computer means for collecting data by said data collection apparatus from said individual user;
means and computer means for communicating said data by said data collection apparatus to said central server through said telecommunication apparatus;
means and computer means for establishing a database associated with each of said data collection apparatus using said data, said database containing said data, said database being administrated by said central server; and
means and computer means for establishing a central database based on said database, said central database being administrated by said central server.

12. The data collection network of claim 11, wherein said data collection apparatus comprises
a power source apparatus, said power source apparatus capable of providing power to said data collection apparatus;
a timing apparatus, said timing apparatus capable of providing date and time information to said data collection apparatus;
a data collecting apparatus, said data collecting apparatus capable of continuously or periodically collecting said data associated with said individual user through said medium, said data being physical data, chemical data, biological data, physiological data, or similar, according to a proprietary algorithm;
a data processing apparatus, said data processing apparatus capable of administrating said data collection apparatus and processing said data collected by said data collecting apparatus, according to said proprietary algorithm;
a data storing apparatus, said data storing apparatus capable of storing said data for a period of time, according to said proprietary algorithm; and
a data communicating apparatus, said data communicating apparatus capable of communicating said data to said central server through said telecommunication apparatus, according to said proprietary algorithm.

13. The data collection network of claim 11, wherein said central server is capable of developing said central database by using some or all of said data from some or all of said database associated with said group of users, analyzing said database, said central database, a part thereof, or a combination thereof, to generate a plurality of reports on said individual user, according to said proprietary algorithm.

14. The data collection network of claim 11, wherein said plurality of reports, used and analyzed in association with said data, from said database, said central database, a part thereof, or a combination thereof, can be used to determine past physical, past biological, past physiological, or past similar condition, and predict future physical, future biological, future physiological, or future similar condition, of said individual user, according to said proprietary algorithm.

15. The data collection network of claim 11, wherein said proprietary algorithm can be improved and modified either manually by an administrator or automatically by said central server based on information associated with said data, said database, said central database, a part thereof, or a combination thereof.

16. A data collection network capable of collecting data from a group of users, said data collection network comprising:
a central server, said central server being an independent server or a plurality of decentralized servers connected through internet;
a data collecting means associated with each of individual user of said group of users;
a closed container means associated with each of said data collecting means, said closed container means containing a medium, said data collecting means disposed within said medium;
a telecommunication means associated with each of said data collecting means, said telecommunication means wirelessly coupling said data collecting means to said central server;
a database associated with each of said data collecting means, said database containing said data collected by said data collecting means, said database being administrated by said central server according to a proprietary algorithm; and
a central database, said central database being administrated by said central server according to said proprietary algorithm.

17. The data collection network of claim 16, wherein said data collecting means comprises
a powering means, said powering means capable of providing power to said data collecting means;
a timing means, said timing means capable of providing date and time information to said data collecting means;
a sensor means, said sensor means being either an individual sensor means or a plurality of sensor means, said sensor means capable of continuously or periodically collecting said data associated with said individual user through said medium, said data being physical data, chemical data, biological data, physiological data, or similar, according to said proprietary algorithm;
a processor, said processor capable of administrating said data collecting means and processing said data, according to said proprietary algorithm;
a data storing means, said data storing means capable of storing said data for a period of time, according to said proprietary algorithm; and
a data communicating means, said data communicating means capable of communicating said data to said central server through said telecommunication means, according to said proprietary algorithm.

18. The data collection network of claim 16, wherein said central server is capable of developing a report, said report being a single report or a plurality of reports, on said individual user based on said data in association with said database, said central database, a part thereof, or a combination thereof, according to said proprietary algorithm.

19. The data collection network of claim 16, wherein said data, said database, said central database, a part thereof, or a combination thereof, can be used to determine past physical, past biological, past physiological, or past similar condition, and predict future physical, future biological, future physiological, or future similar condition, of said individual user, according to said proprietary algorithm.

20. The data collection network of claim 16, wherein said proprietary algorithm can be improved and modified either manually by an administrator or automatically by said central server, according to said proprietary algorithm itself, based on information associated with said data, said database, said central database, a part thereof, or a combination thereof.

21. A data collection method capable of collecting data from a group of users, said data collection method comprising:
providing a central server, said central server being an independent server or a plurality of decentralized servers connected through internet;
providing a data collecting means associated with each of individual user of said group of users;
providing a closed container means associated with each of said data collecting means, said closed container means containing a medium, said data collecting means disposed within said medium;
providing a telecommunication means associated with each of said data collecting means, said telecommunication means wirelessly coupling said data collecting means to said central server;
collecting data by said data collecting means from said individual user;
communicating said data by said data collecting means to said central server through said telecommunication apparatus;
developing a database associated with each of said data collecting means, said database containing said data collected by said data collecting means, said database being administrated by said central server according to a proprietary algorithm; and
developing a central database based on said database, said central database being administrated by said central server according to said proprietary algorithm.

22. The data collection method of claim 21, wherein said data collecting means comprises
a powering means, said powering means capable of providing power to said data collecting means;
a timing means, said timing means capable of providing date and time information to said data collecting means;
a sensor means, said sensor means being either an individual sensor means or a plurality of sensor means, said sensor means capable of continuously or periodically collecting said data associated with said individual user through said medium, said data being physical data, chemical data, biological data, physiological data, or similar, according to said proprietary algorithm;
a processor, said processor capable of administrating said data collecting means and processing said data, according to said proprietary algorithm;
a data storing means, said data storing means capable of storing said data for a period of time, according to said proprietary algorithm; and
a data communicating means, said data communicating means capable of communicating said data to said central server through said telecommunication means, according to said proprietary algorithm.

23. The data collection method of claim 21, wherein said central server is capable of developing a report, said report being a single report or a plurality of reports, on said individual user based on said data in association with said database, said central database, a part thereof, or a combination thereof, according to said proprietary algorithm.

24. The data collection method of claim 21, wherein said data, said database, said central database, a part thereof, or a combination thereof, can be used to determine past physical, past biological, past physiological, or past similar condition, and predict future physical, future biological, future physiological, or future similar condition, of said individual user, according to said proprietary algorithm.

25. The data collection method of claim 21, wherein said proprietary algorithm can be improved and modified either manually by an administrator or automatically by said central server, according to said proprietary algorithm itself, based on information associated with said data, said database, said central database, a part thereof, or a combination thereof.

26. A data collection network capable of collecting data from a group of users, said data collection network comprising:
means and computer means for providing a central server, said central server being an independent server or a plurality of decentralized servers connected through internet;
means and computer means for providing a data collecting means associated with each of individual user of said group of users;
means and computer means for providing a closed container means associated with each of said data collecting means, said closed container means containing a medium, said data collecting means disposed within said medium;
means and computer means for providing a telecommunication means associated with each of said data collecting means, said telecommunication means wirelessly coupling said data collecting means to said central server;
means and computer means for collecting data by said data collecting means from said individual user;
means and computer means for communicating said data by said data collecting means to said central server through said telecommunication apparatus;
means and computer means for developing a database associated with each of said data collecting means, said database containing said data collected by said data collecting means, said database being administrated by said central server according to a proprietary algorithm; and
means and computer means for developing a central database, said central database being administrated by said central server according to said proprietary algorithm.

27. The data collection network of claim 26, wherein said data collecting means comprises
a powering means, said powering means capable of providing power to said data collecting means;
a timing means, said timing means capable of providing date and time information to said data collecting means;
a sensor means, said sensor means being either an individual sensor means or a plurality of sensor means, said sensor means capable of continuously or periodically collecting said data associated with said individual user through said medium, said data being physical data, chemical data, biological data, physiological data, or similar, according to said proprietary algorithm;
a processor, said processor capable of administrating said data collecting means and processing said data, according to said proprietary algorithm;
a data storing means, said data storing means capable of storing said data for a period of time, according to said proprietary algorithm; and
a data communicating means, said data communicating means capable of communicating said data to said central server through said telecommunication means, according to said proprietary algorithm.

28. The data collection network of claim 26, wherein said central server is capable of developing a report, said report being a single report or a plurality of reports, on said individual user based on said data in association with said database, said central database, a part thereof, or a combination thereof, according to said proprietary algorithm.

29. The data collection network of claim 26, wherein said data, said database, said central database, a part thereof, or a combination thereof, can be used to determine past physical, past biological, past physiological, or past similar condition, and predict future physical, future biological, future physiological, or future similar condition, of said individual user, according to said proprietary algorithm.

30. The data collection network of claim 26, wherein said proprietary algorithm can be improved and modified either manually by an administrator or automatically by said central server, according to said proprietary algorithm itself, based on information associated with said data, said database, said central database, a part thereof, or a combination thereof.

31. A data collecting network capable of collecting data from a group of users, said data collecting network comprising:
a data collection apparatus for each of individual user of said group of users;
a closed container associated with each of said data collection apparatus, said closed container having a medium, said data collection apparatus submerged within said medium;
a server, said server remotely coupled with said data collection apparatus; and
a central database, said central database being administrated by said server according to a computer algorithm.

32. The data collection network of claim 31, wherein said data collection apparatus is capable of collecting said data, either continuously or periodically, through said medium and from said individual user, representing impact of said individual user with said closed container, said data being physical data, chemical data, biological data, or similar, according to said computer algorithm.

33. The data collection network of claim 31, wherein said data collection apparatus comprises at least
a power source apparatus, said power source apparatus capable of providing power to said data collection apparatus;
a data collecting apparatus, said data collecting apparatus capable of collecting said data, either continuously or periodically, through said medium and from said individual user, according to said computer algorithm;
a data processing apparatus, said data processing apparatus capable of administrating said data collection apparatus according to said computer algorithm; and
a data communicating apparatus, said data communicating apparatus capable of communicating said data to said server according to said computer algorithm.

34. The data collection network of claim 31, wherein said server is capable of developing an individual report, said individual report being a single individual report or a plurality of individual reports, on said individual user based on said data in association with said central database, a part thereof, or a combination thereof, according to said proprietary algorithm.

35. The data collection network of claim 31, wherein said server is capable of developing a group report, said group report being a single group report or a plurality of group reports, on said group of users, or a sub-group of said group of users, based on said data in association with said central database, a part thereof, or a combination thereof, according to said computer algorithm.

36. The data collection network of claim 31, wherein said data, said central database, a part thereof, or a combination thereof, can be used to determine past physical, past biological, past physiological, or past similar condition, and predict future physical, future biological, future physiological, or future similar condition, of said individual user, according to said computer algorithm.

37. The data collection network of claim 31, wherein said data, said central database, a part thereof, or a combination thereof, can be used to determine past physical condition, and predict future physical condition, of said group of users, or said sub-group of said group of users, according to said computer algorithm.

38. The data collection network of claim 31, wherein said computer algorithm can be improved and modified either manually by an administrator or automatically, according to said computer algorithm itself, by said server based on information associated with said data, said central database, a part thereof, or a combination thereof.

39. A data collecting method capable of collecting data from a group of users, said data collecting method comprising:
providing a data collection apparatus for each of individual user of said group of users;
providing a closed container associated with each of said data collection apparatus, said closed container having a medium, said data collection apparatus submerged within said medium;
providing a server, said server remotely coupled with said data collection apparatus;
establishing a central database, said central database being administrated by said server according to a computer algorithm.

40. The data collection method of claim 39, wherein said data collection apparatus is capable of collecting said data, either continuously or periodically, through said medium and from said individual user, representing impact of said individual user with said closed container, said data being physical data, chemical data, biological data, physiological data, or similar, according to said computer algorithm.

41. The data collection method of claim 39, wherein said data collection apparatus comprises at least a power source apparatus, said power source apparatus capable of providing power to said data collection apparatus;
a data collecting apparatus, said data collecting apparatus capable of collecting said data, either continuously or periodically, through said medium and from said individual user, according to said computer algorithm;
a data processing apparatus, said data processing apparatus capable of administrating said data collection apparatus according to said computer algorithm; and
a data communicating apparatus, said data communicating apparatus capable of communicating said data to said server according to said computer algorithm.

42. The data collection method of claim 39, wherein said server is capable of developing an individual report, said individual report being a single individual report or a plurality of individual reports, on said individual user based on said data in association with said central database, a part thereof, or a combination thereof, according to said proprietary algorithm.

43. The data collection method of claim 39, wherein said server is capable of developing a group report, said group report being a single group report or a plurality of group reports, on said group of users, or a sub-group of said group of users, based on said data in association with said central database, a part thereof, or a combination thereof, according to said computer algorithm.

44. The data collection method of claim 39, wherein said data, said central database, a part thereof, or a combination thereof, can be used to determine past physical or past similar condition, and predict future physical or future similar condition, of said individual user, according to said computer algorithm.

45. The data collection method of claim 39, wherein said data, said central database, a part thereof, or a combination thereof, can be used to determine past physical or past similar condition, and predict future physical or future similar condition, of said group of users, or said sub-group of said group of users, according to said computer algorithm.

48. The data collection method of claim 39, wherein said computer algorithm can be improved and modified either manually by an administrator or automatically by said server, according to said computer algorithm itself, based on information associated with said data, said central database, a part thereof, or a combination thereof.

47. A data collecting network capable of collecting data from a group of users, said data collecting method comprising:
means and computer means for providing a data collection apparatus for each of individual user of said group of users;
means and computer means for providing a closed container associated with each of said data collection apparatus, said closed container having a medium, said data collection apparatus submerged within said medium;
means and computer means for providing a server, said server remotely coupled with said data collection apparatus; and
means and computer means for establishing a central database, said central database being administrated by said server according to a computer algorithm.

48. The data collection network of claim 47, wherein said data collection apparatus is capable of collecting said data, either continuously or periodically, through said medium and from said individual user, representing impact of said individual user with said closed container, said data being physical data, biological data, or similar, according to said computer algorithm.

49. The data collection network of claim 47, wherein said data collection apparatus comprises at least a power source apparatus, said power source apparatus capable of providing power to said data collection apparatus;
a data collecting apparatus, said data collecting apparatus capable of collecting said data, either continuously or periodically, through said medium and from said individual user, according to said computer algorithm;
a data processing apparatus, said data processing apparatus capable of administrating said data collection apparatus according to said computer algorithm; and
a data communicating apparatus, said data communicating apparatus capable of communicating said data to said server according to said computer algorithm.

50. The data collection network of claim 47, wherein said server is capable of developing an individual report, said individual report being a single individual report or a plurality of individual reports, on said individual user based on said data in association with said central database, a part thereof, or a combination thereof, according to said proprietary algorithm.

51. The data collection network of claim 47, wherein said server is capable of developing a group report, said group report being a single group report or a plurality of group reports, on said group of users, or a sub-group of said group of users, based on said data in association with said central database, a part thereof, or a combination thereof, according to said computer algorithm.

52. The data collection network of claim 47, wherein said data, said central database, a part thereof, or a combination thereof, can be used to determine past physical, past biological, or past similar condition, and predict future physical, future biological, or future similar condition, of said individual user, according to said computer algorithm.

53. The data collection network of claim 47, wherein said data, said central database, a part thereof, or a combination thereof, can be used to determine past physical, past biological, or past similar condition, and predict future physical, future biological, or future similar condition, of said group of users, or said sub-group of said group of users, according to said computer algorithm.

54. The data collection network of claim 47, wherein said computer algorithm can be improved and modified either manually by an administrator or automatically by said server, according to said computer algorithm itself, based on information associated with said data, said central database, a part thereof, or a combination thereof.

55. A data collection method capable of collecting data from a group of users, said data collecting method comprising:
providing a data collection apparatus to each of individual user of said group of users;
registering said individual user to said data collection apparatus;
providing a closed container associated with each of said data collection apparatus, said closed container containing a medium, said data collection apparatus disposed within said medium;
providing a central server, said central server being an independent server or a plurality of decentralized servers connected through internet;
registering said data collection apparatus to said central server;
providing a telecommunication apparatus associated with each of said data collection apparatus, said telecommunication apparatus wirelessly coupling said data collection apparatus to said central server;
registering said telecommunication apparatus to said central server;
establishing a database associated with each of said data collection apparatus, said database containing said data collected by said data collection apparatus, said database being administrated by said central server according to an algorithm;
establishing a central database, said central database being administrated by said central server according to said algorithm;
collecting said data by said data collection apparatus from said individual user through said medium, said data describing and representing impact of said individual user with said closed container, according to said algorithm;
processing said data by said data collection apparatus according to said algorithm;
communicating said data by said data collection apparatus to said central server through said telecommunication apparatus according to said algorithm;
developing said database by said central server based on said data according to said algorithm;
developing said central database by said central server based on said data according to said algorithm;
analyzing said data, said database, said central database, a part thereof, or a combination thereof, by said central server, said data communication apparatus, said data collection apparatus, or a combination thereof, according to said algorithm;
producing an individual report, said individual report being a single individual report or a plurality of individual reports, on said individual user, according to said algorithm;
producing a group report, said group report being a single group report or a plurality of group reports, on said group of individual users, or a sub-group of said group of individual users, according to said algorithm; and
improving and modifying said algorithm either manually by an administrator or automatically by said server, according to said algorithm, based on information associated with said data, said database, said central database, a part thereof, or a combination thereof.

56. The data collection method of claim 55, wherein said data collection apparatus comprises
a power source apparatus, said power source apparatus capable of providing power to said data collection apparatus;
a timing apparatus, said timing apparatus capable of providing date and time information to said data collection apparatus;
a data collecting apparatus, said data collecting apparatus capable of continuously or periodically collecting said data associated with said individual user, according to said algorithm;
a data processing apparatus, said data processing apparatus capable of administrating said data collection apparatus and processing said data collected by said data collecting apparatus, according to said algorithm;
a data storing apparatus, said data storing apparatus capable of storing said data for a period of time, according to said algorithm; and
a data communicating apparatus, said data communicating apparatus capable of communicating said data to said central server through said telecommunication apparatus, according to said algorithm.

57. The data collection method of claim 55, wherein said individual report, used and analyzed in association with said data, from said database, said central database, or a combination thereof, can be used to determine past physical, past biological, or past similar condition, and predict future physical, future biological, or future similar condition, of said individual user, according to said algorithm.

58. The data collection method of claim 55, wherein said group report, used and analyzed in association with said data, from said database, said central database, or a combination thereof, can be used to determine past physical, past biological, or past similar condition, and predict future physical, future biological, or future similar condition, of said group of users, or a sub-group of said group of users, according to said algorithm.

59. A data collection network capable of collecting data from a group of users, said data collecting network comprising:
means and computer means for providing a data collection apparatus to each of individual user of said group of users;
means and computer means for registering said individual user to said data collection apparatus;
means and computer means for providing a closed container associated with each of said data collection apparatus, said closed container containing a medium, said data collection apparatus disposed within said medium;
means and computer means for providing a central server, said central server being an independent server or a plurality of decentralized servers connected through internet;
means and computer means for registering said data collection apparatus to said central server;
means and computer means for providing a telecommunication apparatus associated with each of said data collection apparatus, said telecommunication apparatus wirelessly coupling said data collection apparatus to said central server;
means and computer means for registering said telecommunication apparatus to said central server;
means and computer means for establishing a database associated with each of said data collection apparatus, said database containing said data collected by said data collection apparatus, said database being administrated by said central server according to an algorithm;
means and computer means for establishing a central database, said central database being administrated by said central server according to said algorithm;
means and computer means for collecting said data by said data collection apparatus from said individual user through said medium, said data describing and representing impact of said individual user with said closed container, according to said algorithm;
means and computer means for processing said data by said data collection apparatus according to said algorithm;
means and computer means for communicating said data by said data collection apparatus to said central server through said telecommunication apparatus according to said algorithm;
means and computer means for developing said database by said central server based on said data according to said algorithm;
means and computer means for developing said central database by said central server based on said data according to said algorithm;
means and computer means for analyzing said data, said database, said central database, a part thereof, or a combination thereof, by said central server, said data communication apparatus, said data collection apparatus, or a combination thereof, according to said algorithm;
means and computer means for producing an individual report, said individual report being a single individual report or a plurality of individual reports, on said individual user, according to said algorithm;
means and computer means for producing a group report, said group report being a single group report or a plurality of group reports, on said group of individual users, or a sub-group of said group of individual users, according to said algorithm; and
means and computer means for improving and modifying said algorithm either manually by an administrator or automatically by said server, according to said algorithm, based on information associated with said data, said database, said central database, a part thereof, or a combination thereof.

60. The data collection network of claim 59, wherein said data collection apparatus comprises
a power source apparatus, said power source apparatus capable of providing power to said data collection apparatus;
a timing apparatus, said timing apparatus capable of providing date and time information to said data collection apparatus;
a data collecting apparatus, said data collecting apparatus capable of continuously or periodically collecting said data associated with said individual user, according to said algorithm;
a data processing apparatus, said data processing apparatus capable of administrating said data collection apparatus and processing said data collected by said data collecting apparatus, according to said algorithm;
a data storing apparatus, said data storing apparatus capable of storing said data for a period of time, according to said algorithm; and
a data communicating apparatus, said data communicating apparatus capable of communicating said data to said central server through said telecommunication apparatus, according to said algorithm.

61. The data collection network of claim 59, wherein said individual report, used and analyzed in association with said data, from said database, said central database, or a combination thereof, can be used to determine past physical, past biological, or past similar condition, and predict future physical, future biological, or future similar condition, of said individual user, according to said algorithm.

62. The data collection network of claim 59, wherein said group report, used and analyzed in association with said data, from said database, said central database, or a combination thereof, can be used to determine past physical, past biological, or past similar condition, and predict future physical, future biological, or future similar condition, of said group of users, or a sub-group of said group of users, according to said algorithm.

63. A data collection method capable of collecting data from a group of users, said data collecting method comprising:
providing a central server, said central server being an independent server or a plurality of decentralized servers connected through internet;
registering a group of users to said central server;
registering a data collection apparatus to each of individual user of said group of users and said central server;
registering a closed container associated with each of said data collection apparatus to said central server, said closed container containing a medium, said data collection apparatus disposed within said medium;
registering a telecommunication apparatus associated with each of said data collection apparatus to said central server, said telecommunication apparatus wirelessly coupling said data collection apparatus to said central server and capable of communicating with said central server;
establishing a database associated with each of said data collection apparatus, said database containing said data collected by said data collection apparatus and communicated to said central server, said database being administrated by said central server according to an algorithm;
establishing a central database, said central database being developed from said data and said database, and administrated by said central server according to said algorithm;
collecting said data by said data collection apparatus from said individual user through said medium either continuously or periodically, said data describing and representing impact of said individual user with said closed container, according to said algorithm;
processing said data by said data collection apparatus according to said algorithm;
communicating said data by said data collection apparatus to said central server through said telecommunication apparatus according to said algorithm;
developing said database by said central server based on said data according to said algorithm;
developing said central database by said central server based on said data according to said algorithm;
analyzing said data, said database, said central database, a part thereof, or a combination thereof, by said central server, said data communication apparatus, said data collection apparatus, or a combination thereof, according to said algorithm;
producing an individual report, said individual report being a single individual report or a plurality of individual reports, on said individual user, according to said algorithm;
producing a group report, said group report being a single group report or a plurality of group reports, on said group of individual users, or a sub-group of said group of individual users, according to said algorithm; and
improving and modifying said algorithm either manually by an administrator or automatically by said server, according to said algorithm, based on information associated with said data, said database, said central database, a part thereof, or a combination thereof.

64. The data collection method of claim 63, wherein said data collection apparatus comprises at least
a power source apparatus, said power source apparatus capable of providing power to said data collection apparatus;
a timing apparatus, said timing apparatus capable of providing date and time information to said data collection apparatus;
a data collecting apparatus, said data collecting apparatus capable of continuously or periodically collecting said data associated with said individual user, according to said algorithm;
a data processing apparatus, said data processing apparatus capable of administrating said data collection apparatus and processing said data collected by said data collecting apparatus, according to said algorithm;
a data storing apparatus, said data storing apparatus capable of storing said data for a period of time, according to said algorithm; and
a data communicating apparatus, said data communicating apparatus capable of communicating said data to said central server through said telecommunication apparatus, according to said algorithm.

65. The data collection method of claim 63, wherein said individual report, used and analyzed in association with said data, from said database, said central database, or a combination thereof, can be used to determine past condition, and predict future condition, of said individual user, according to said algorithm.

66. The data collection method of claim 63, wherein said group report, used and analyzed in association with said data, from said database, said central database, or a combination thereof, can be used to determine past condition, and predict future condition, of said group of users, or a sub-group of said group of users, according to said algorithm.

67. A data collection network capable of collecting data from a group of users, said data collecting network comprising:
means and computer means for providing a central server, said central server being an independent server or a plurality of decentralized servers connected through internet;
means and computer means for registering a group of users to said central server;
means and computer means for registering a data collection apparatus to each of individual user of said group of users and said central server;
means and computer means for registering a closed container associated with each of said data collection apparatus to said central server, said closed container containing a medium, said data collection apparatus disposed within said medium;
means and computer means for registering a telecommunication apparatus associated with each of said data collection apparatus to said central server, said telecommunication apparatus wirelessly coupling said data collection apparatus to said central server and capable of communicating with said central server;
means and computer means for establishing a database associated with each of said data collection apparatus, said database containing said data collected by said data collection apparatus and communicated to said central server, said database being administrated by said central server according to an algorithm;
means and computer means for establishing a central database, said central database being developed from said data and said database, and administrated by said central server according to said algorithm;
means and computer means for collecting said data by said data collection apparatus from said individual user through said medium either continuously or periodically, said data describing and representing impact of said individual user with said closed container, according to said algorithm;
means and computer means for processing said data by said data collection apparatus according to said algorithm;
means and computer means for communicating said data by said data collection apparatus to said central server through said telecommunication apparatus according to said algorithm;
means and computer means for developing said database by said central server based on said data according to said algorithm;
means and computer means for developing said central database by said central server based on said data according to said algorithm;
means and computer means for analyzing said data, said database, said central database, a part thereof, or a combination thereof, by said central server, said data communication apparatus, said data collection apparatus, or a combination thereof, according to said algorithm;
means and computer means for producing an individual report, said individual report being a single individual report or a plurality of individual reports, on said individual user, according to said algorithm;
means and computer means for producing a group report, said group report being a single group report or a plurality of group reports, on said group of individual users, or a sub-group of said group of individual users, according to said algorithm; and
means and computer means for improving and modifying said algorithm either manually by an administrator or automatically by said server, according to said algorithm, based on information associated with said data, said database, said central database, a part thereof, or a combination thereof.

68. The data collection network of claim 67, wherein said data collection apparatus comprises at least
a power source apparatus, said power source apparatus capable of providing power to said data collection apparatus;
a timing apparatus, said timing apparatus capable of providing date and time information to said data collection apparatus;
a data collecting apparatus, said data collecting apparatus capable of continuously or periodically collecting said data associated with said individual user, according to said algorithm;
a data processing apparatus, said data processing apparatus capable of administrating said data collection apparatus and processing said data collected by said data collecting apparatus, according to said algorithm;
a data storing apparatus, said data storing apparatus capable of storing said data for a period of time, according to said algorithm; and
a data communicating apparatus, said data communicating apparatus capable of communicating said data to said central server through said telecommunication apparatus, according to said algorithm.

69. The data collection network of claim 67, wherein said individual report, used and analyzed in association with said data, from said database, said central database, or a combination thereof, can be used to determine past condition, and predict future condition, of said individual user, according to said algorithm.

70. The data collection method of claim 67, wherein said group report, used and analyzed in association with said data, from said database, said central database, or a combination thereof, can be used to determine past condition, and predict future condition, of said group of users, or a sub-group of said group of users, according to said algorithm.
